(19) United States
(12) Patent Application Publication
(10) Pub. No.: US 2026/0142736 A1
(43) Pub. Date: May 21, 2026

(54) DETERMINING INTERFERENCE IN A COMMUNICATION CHANNEL

(71) Applicant: LitePoint Corporation, San Jose, CA (US)

(72) Inventors: Chen Cao, Shanghai (CN); Vito Laio, Taipei City (TW); Christian Volf Olgaard, Saratoga, CA (US); Ruizu Wang, San Jose, CA (US); Qingjie Lu, Shanghai (CN)

(73) Assignee: LitePoint Corporation, San Jose, CA (US)

(21) Appl. No.: 18/968,307

(22) Filed: Dec. 4, 2024

(30) Foreign Application Priority Data
Nov. 20, 2024 (CN) 202411666419.0

(51) Int. Cl. H04B 17/345

(52) U.S. Cl. CPC H04B 17/345

(57) ABSTRACT

An example system is configured to measure power based on a first signal in a first frequency band. The first signal includes an interference component of a second signal in a second frequency band that is adjacent to the first frequency band. The system includes a lowpass filter (LPF) having a fixed frequency. The system includes circuitry configured to perform operations that include changing a frequency using a local oscillator to shift a center frequency of the first signal into an LPF; obtaining measurements of power of the interference component at windows in the first frequency band where an attenuation of the LPF is at or above a predefined value; and determining the power of the interference component in the first frequency band based on the measurements so as to reduce an aliasing component in the first signal caused by the LPF.

### TECHNICAL FIELD

This specification describes example implementations of techniques for determining interference in a communication channel.

### BACKGROUND

A test system is configured to test the operation of a device. A device tested by a test system is referred to as a device under test (DUT). A DUT that transmits wireless signals, such as radio frequency (RF) signals, may be configured to transmit signals in a predefined communication channel, or frequency band. RF signals transmitted by a DUT in the communication channel may produce interference in one or more adjacent communication channels.

### SUMMARY

An example method is for measuring power based on a first signal in a first frequency band. The first signal includes an interference component of a second signal in a second frequency band that is adjacent to the first frequency band. The first signal may be subject to an aliasing component from a lowpass filter (LPF). An example implementation of the method uses a fixed LPF having large attenuation in some portions of its stopband. By changing a down conversion frequency using a local oscillator (LO), the same portion of a radio frequency (RF) signal will get attenuated differently by the LPF. A portion of the aliasing component will get attenuated by the high attenuation in the stopband. By combining multiple measurements at different frequencies, the contribution to the first signal from the aliasing component can be reduced, removed, or eliminated.

The method may include changing a frequency using an LO to shift a center frequency of the first signal into an LPF; obtaining measurements of power of the interference component at windows in the first frequency band where an attenuation of the LPF is at or above a predefined value; and determining the power of the interference component in the first frequency band based on the measurements so as to reduce an aliasing component in the first signal caused by the LPF. The method may include one or more of the following features, either alone or in combination.

Obtaining the measurements where the attenuation of the LPF is at or above the predefined value removes all or some signal power of the aliasing component from the determined power of the interference component. Obtaining the measurements may include the following operations: obtaining a bandwidth of a window; placing a digital baseband in a center of the first frequency band; placing the window relative to the digital baseband center based on an offset, where placing the window includes shifting a frequency in the first frequency band; measuring the power of the interference component in the window; and repeating the placing and measuring operations for different values of the offset to obtain the measurements. Measuring may be performed using a vector signal analyzer (VSA).

The offset, Δf may be defined as follows:

$$Δ f = {f}_{{H}_{{f}_{s}}}^{*} - f$$

where f is the digital baseband center frequency and

$${f}_{{H}_{{f}_{s}}}^{*}$$

is a frequency where the attenuation of the LPF is at or above the predefined value. Setting the offset may include changing a value of

$${f}_{{H}_{{f}_{s}}}^{*}$$

at each repetition. The value of

$${f}_{{H}_{{f}_{s}}}^{*}$$

may be changed at each repetition so that the window covers all frequencies in the first frequency band.

The bandwidth of the window may be settable based on at least one of a target performance or a target test time. Determining the power may include summing the measurements.

The second signal in the second frequency band may be generated by a device under test (DUT). The method may include comparing the power of the interference component to a predefined threshold to test the DUT. Obtaining the measurements may be performed by a VSA configured to measure signals in less than an entirety of the first frequency band plus the second frequency band.

The predefined value may be a minimum value among multiple values that are attenuations produced by the LPF. The predefined value may be zero in a Z-plane of the LPF.

An example system is configured to measure power based on a first signal in a first frequency band. The first signal includes an interference component of a second signal in a second frequency band that is adjacent to the first frequency band. The system includes an LPF having a fixed frequency response. The system includes circuitry configured to perform operations that include changing a frequency using an LO to shift a center frequency of the first signal into an LPF; obtaining measurements of power of the interference component at windows in the first frequency band where an attenuation of the LPF is at or above a predefined value; and determining the power of the interference component in the first frequency band based on the measurements so as to reduce an aliasing component in the first signal caused by the LPF. The system may include one or more of the following features, either alone or in combination.

Obtaining the measurements where the attenuation of the LPF is at or above the predefined value removes all or some signal power of the aliasing component from the determined power of the interference component. Obtaining the measurements may include the following operations: obtaining a bandwidth of a window; placing a digital baseband in a center of the first frequency band; placing the window relative to the digital baseband center based on an offset, where placing the window includes shifting a frequency in the first frequency band; measuring the power of the interference component in the window; and repeating placing and measuring for different values of the offset to obtain the measurements.

At least part of the circuitry may be in a VSA. At least part of the circuitry may include one or more processing devices and memory storing instructions that are executable by the one or more processing devices. At least part of the circuitry may include one or more solid state electronic devices.

The offset, Δf may be as follows:

$$Δ f = {f}_{{H}_{{f}_{*}}}^{*} - f$$

where f is the digital baseband center frequency and

$${f}_{{H}_{{f}_{s}}}^{*}$$

is a frequency where the attenuation of the LPF is at or above the predefined value. Setting the offset may include changing a value of

$${f}_{{H}_{{f}_{s}}}^{*}$$

at each repetition. The value of

$${f}_{{H}_{{f}_{s}}}^{*}$$

may be changed at each repetition so that the window covers all frequencies in the first frequency band.

The bandwidth of the window may be settable based on at least one of a target resolution or a target test time. Determining the power may include summing the measurements.

The second signal in the second frequency band may be generated by a DUT. The system may include test equipment configured to compare the power of the interference component to a predefined threshold to test the DUT.

The predefined value may be a minimum value among multiple values that are attenuations produced by the LPF. The predefined value may be zero in a Z-plane of the LPF.

Any two or more of the features described in this specification, including in this summary section, may be combined to form implementations not specifically described in this specification.

At least part of the devices, systems, circuitry, and processes described in this specification may be configured or controlled by executing, on one or more processing devices, instructions that are stored on one or more non-transitory machine-readable storage media. Examples of non-transitory machine-readable storage media include read-only memory, an optical disk drive, memory disk drive, and random access memory. At least part of the devices, systems, circuitry, and processes described in this specification may be configured or controlled using a computing system comprised of one or more processing devices and memory storing instructions that are executable by the one or more processing devices to perform various control operations. The devices, systems, circuitry, and processes described in this specification may be configured, for example, through design, construction, composition, arrangement, placement, programming, operation, activation, deactivation, and/or control.

The details of one or more implementations are set forth in the accompanying drawings and the following description. Other features and advantages will be apparent from the description and drawings, and from the claims.

### DESCRIPTION OF THE DRAWINGS

FIG. 1 is a block diagram of example test system components including a control system and components of an example vector signal analyzer.

FIG. 2 is a graph showing an example channel over which a device under test (DUT) transmits a signal and an adjacent channel containing interference and aliasing produced by measurement in the example channel.

FIG. 3 is a graph showing an example signal power measurement in an adjacent channel caused by interference from the signal transmitted by the DUT and aliasing.

FIG. 4 is a graph showing example frequency responses of an example lowpass filter that may be part of a vector signal analyzer.

FIG. 5 is a flowchart showing example operations included in an example process for determining interference in a channel that removes, reduces, or minimizes the aliasing from the determined interference.

FIG. 6 is a graph showing an example channel over which a DUT transmits a signal, an adjacent channel containing interference and aliasing, and a sliding window in which measurements of, or based on, signal power may be obtained.

FIG. 7 is a graph showing the example channel of FIG. 6 in which the sliding window is in a different location in the channel than in FIG. 6.

FIG. 8 is a plot showing example determinations of signal power obtained using prior art techniques and the systems and processes described herein.

FIG. 9 is another plot showing example determinations of signal power obtained using prior art techniques and the systems and processes described herein.

Like reference numerals in different figures indicate like elements.

### DETAILED DESCRIPTION

Described herein are examples of systems and processes for determining the power of an interference signal in a frequency band. The interference signal, which is also referred to as an interference component, is produced by a device signal in an adjacent frequency band. That is, the interference signals is an artifact, or component, of the device signal and, therefore, may be referred to as an interference component. The frequency bands define different communication channels (“channels”) over which signals may be sent between a device under test (DUT) and a test system. Therefore, the terms “frequency band” and “channel” may be used interchangeably.

The DUT may be any type of electronic device such as, but not limited to, a radio frequency (RF) transceiver configured to implement wireless communications such as cellular, WiFi, Bluetooth, or GPS (global positioning system) functionality.

The systems and processes described herein may use a vector signal analyzer (VSA) to obtain measurements of, or based on, the power of an interference component in a channel. An example VSA may be configured to measure an amplitude and phase of a signal at a frequency that is within a bandwidth of the VSA.

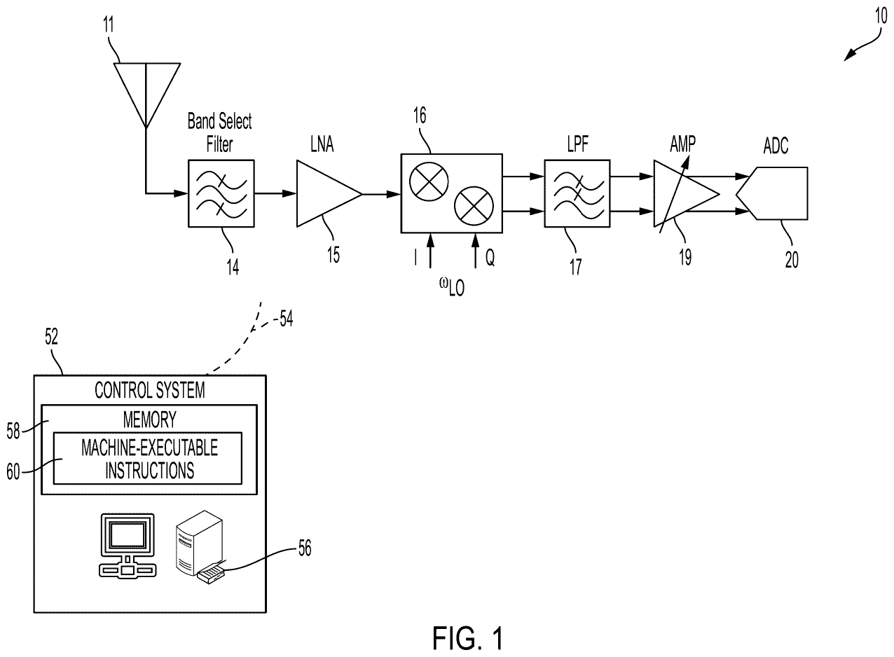

FIG. 1 shows example components that may be included in an example VSA 10 that may be used to implement at least part of the systems and processes described herein. The components implement a direct down conversion receiver configured to demodulate an RF signal using synchronous detection driven by a local oscillator (LO).

Example VSA 10 includes an antenna 11 to receive an RF signal from a channel, a band select filter 14 to select signals in a predefined channel or frequency band, a low noise amplifier (LNA) 15 to amplify selected signals, a frequency mixer 16 having a frequency that is driven by the frequency of a VSA LO, a lowpass filter (LPF) 17, an amplifier 19, and an analog-to-digital converter (ADC) 20. In some implementations, the measurements described herein may be performed without using antenna. For example, there may be wired (e.g., coaxial) connection in place of the antenna, which is configured to receive RF signals.

When testing a DUT using a VSA, the VSA obtains out-of-band (or channel) power measurements to ensure that the DUT's interference on adjacent channels is constrained under specifications. Such tests may include, for example spectrum emission mask tests, adjacent channel leakage tests, and occupied bandwidth tests.

As the DUT signal's bandwidth gets wider, the required bandwidth of the VSA may need to increase. For less expensive test instruments having VSAs that can cover only one channel, to measure the out-of-band signals produced by a DUT, an example method is to move the VSA RF center frequency to the adjacent channel and measure the adjacent channel only, e.g., put the DUT signal out of the VSA's bandwidth.

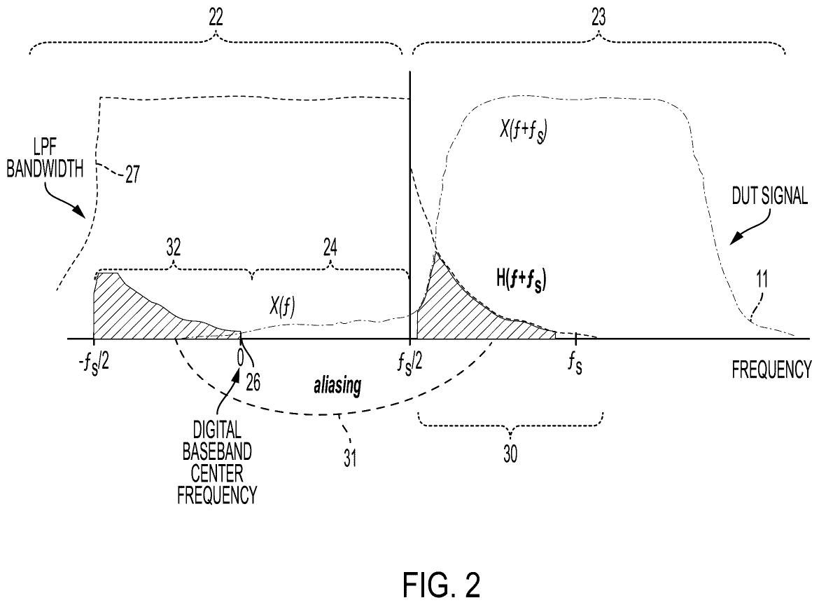

However, because of the limited performance of the LPF 17 in the VSA, part of the device covered by the LPF will be converted into the VSA digital baseband as false signal power—referred to as aliasing or an aliasing component—in a channel adjacent to the channel containing the DUT signal. FIG. 2 illustrates this phenomenon.

More specifically, FIG. 2 shows two adjacent channels (frequency bands) 22, 23, which may be of equal bandwidth or substantially equal bandwidth (e.g., ±5% or ±10% difference in some examples). DUT signal 11 is mostly in channel 23. An interference signal/component 24 is in channel 22. The interference signal/component may be caused, e.g., by power leakage from DUT signal 11 into channel 22.

The digital baseband center 26 of VSA 10 is labeled 0. [−fₛ/2, fₛ/2] is the available baseband range of LPF 17 in the example shown in FIG. 2, where fₛ is the center frequency of DUT signal 11 as explained below. The bandwidth 27 of LPF 17 covers channel 22. However, as shown in FIG. 2, LPF 17 is imperfect and, therefore, its bandwidth 27 also covers part 30 of channel 23. This results in power from DUT signal 11 reflecting 31 back into channel 22 as the aliasing component 32. In some implementations, the aliasing assumes In-phase/Quadrature sampling (I/Q) inside the VSA. The aliasing component corrupts measurements of, or based on, the interference component 24 in channel 22 obtained by VSA 10. The systems and processes described herein are configured to determine the power of the interference component in channel 22 in such as a way as to remove, to reduce, and/or to minimize the signal power of the aliasing component in the determined power of the interference component.

By way of example, referring to FIGS. 1 and 2, from sampling theory, for a received RF signal x(t) (such as a DUT signal) and an LPF 17 h_{f}_{ₛ}(t), the digital signal IQ (In-phase, Quadrature) samples, y(n), after ADC 20 having a sampling rate fₛ are characterized as

$$y ( n ) = \int \int x ( τ ) {h}_{{f}_{*}} ( t - τ ) δ ( t - n / {f}_{s} ) d τ dt \qquad ( 1 )$$

The baseband frequency domain signal, Y(f), is defined as follows.

$$\begin{matrix}Y ( f ) = {\sum }_{k} X ( f + {kf}_{s} ) {H}_{{f}_{*}} ( f + {kf}_{s} ) , & ∀ \vert f \vert < {f}_{s} / 2\end{matrix} \qquad ( 2 )$$

The DUT signal 11, X(f), in channel 23 is centered around fₛ and H_{f}_{ₛ}(f) is centered at f=0 with a cut-off frequency fₛ/2.

Assume an example in which the DUT signal 11 is centered at the right side of the VSA bandwidth, and assume that LPF 17 has an attenuation of one within an in-band region such as channel 23. This results in the following simplified version of equation (2) above.

$$\begin{matrix}Y ( f ) = X ( f ) + X ( f + {f}_{s} ) {H}_{{f}_{*}} ( f + {f}_{s} ) , & ∀ \vert f \vert < {f}_{s} / 2\end{matrix} \qquad ( 3 )$$

This equation shows that the determined, e.g., measured, power of an interference component in a channel 22 adjacent to the channel 23 in which the DUT signal 11 is transmitted includes DUT adjacent channel interference X(f) 24 and an aliasing component 32 X(f+fₛ) H_{f}_{ₛ}(f+fₛ) from the DUT channel 23.

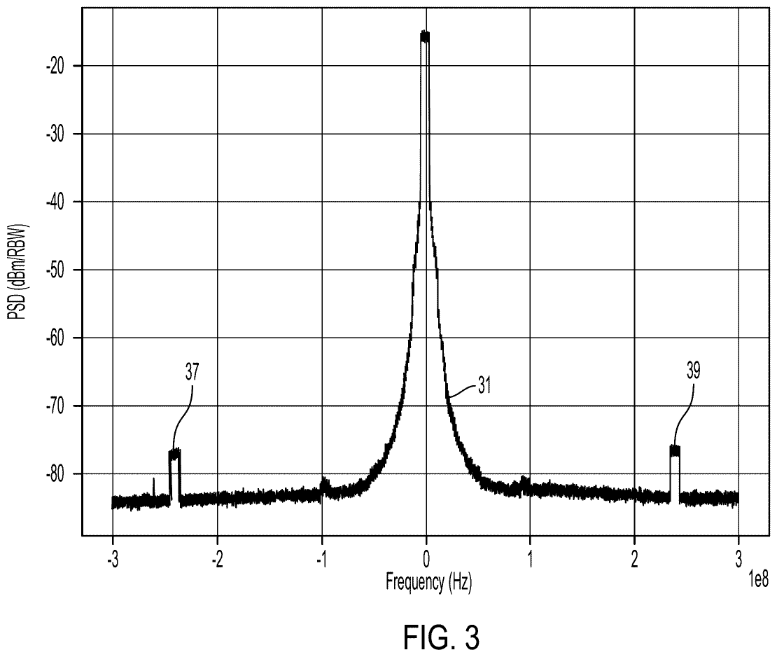

FIG. 3 shows a measurement 36 taken by a VSA (e.g., 10, FIG. 1) of the power spectral density (PSD) (in decibel-milliwatts (dBm)/RBW) versus frequency (in hertz (HZ)) of an example interference component (e.g., 24. FIG. 2) of a DUT signal (e.g., 11, FIG. 2) in an adjacent channel (e.g., 22, FIG. 2). In this example, FIG. 3 is obtained by combining/stitching together multiple VSA captures performed at different RF frequencies. In this example, the VSA was centered at left-200 MHz (megahertz), center 0 MHz, and right 200 MHz, respectively, of the DUT signal channel (e.g., 23). The example VSA has a 240 MHz sampling rate but 200 MHz flatness. That is why the stitching is at 200 MHz. The math here describes the frequency range that a discrete signal (IQ samples) can see. A narrow bandwidth signal was used to make the impact more prominent to observe. In this example, the aliasing component 37, 39 from the DUT signal at the ADC (e.g., 20, FIG. 1) sampling rate (240 MHz) is in the left and right VSA captures. The aliasing component contributes to an incorrect DUT adjacent channel interference (e.g., leakage power) measurement.

To remove, to reduce, and/or to minimize the foregoing aliasing component, which is represented as X(f+fₛ) H_{f}_{ₛ}(f+fₛ), example implementations of the systems and processes described herein use the attenuation of the LPF (e.g., 17, FIG. 1) and a reduced (e.g., minimized) the LPF frequency response H_{f}_{ₛ}(f+fₛ).

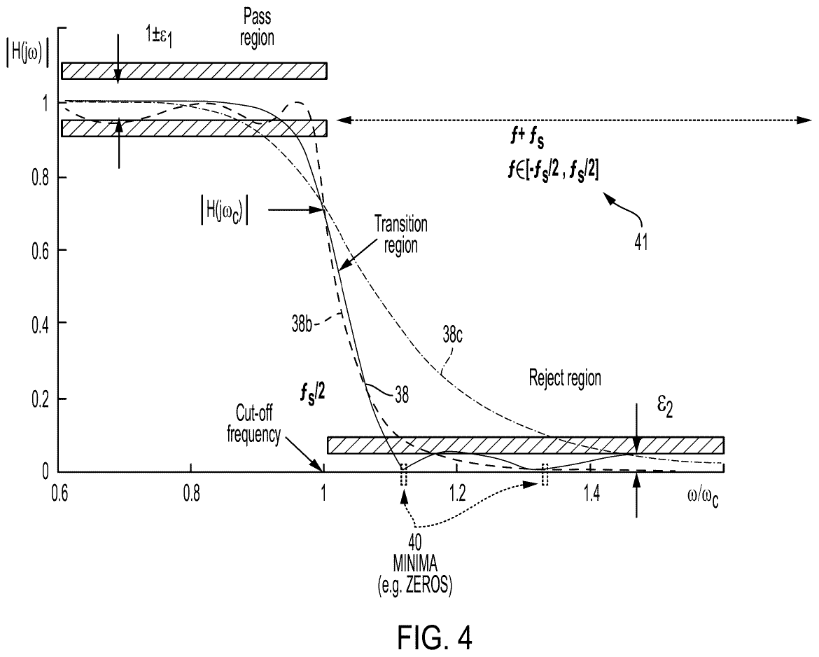

FIG. 4 shows an example frequency response 38 of example LPF 17. In this example, the cut-off frequency” is for the LPF, and the angular frequency ω is normalized to the “cut-off frequency” ωc, where ω/ωc is the x axis. The cut-off frequency can be put anywhere based on what is to be optimized. In the example of FIG. 4, there are three different filter responses, two of which have nulls in stop band. Two of the frequency responses 38b, 38c are in dashed lines. In some implementations, these two are not used in the processes described herein.

As shown in FIG. 4, the discrete signal frequency range is [−fₛ/2, fₛ/2] 41 (that is the Nyquist frequency), and, the frequency value(s) 40 at which the LPF filer has the greatest attenuation,

$${f}_{{H}_{{f}_{s}}}^{*} ,$$

can be defined as follows.

$${f}_{{H}_{{f}_{x}}}^{*} = arg {min}_{f ∈ [ - {f}_{s} / 2 , {f}_{x} / 2 ]} {H}_{{f}_{x}} ( f + {f}_{s} ) \qquad ( 4 )$$

$${f}_{{H}_{{f}_{s}}}^{*} + {f}_{s}$$

is the baseband frequency that leads to the maximum attenuation of the LPF. For example, if any zero (s-plane) exists at a unit circle within [fₛ−fₛ/2, fₛ+fₛ/2], then

$${f}_{{H}_{{f}_{s}}}^{*} + {f}_{s}$$

will be the frequency of this zero. Therefore, to reduce (e.g., to minimize) the power (Pₐₗᵢₛ)—e.g., “min Pₐᵢₗₛ” below—of the aliasing component with a to-be-measured bandwidth BW, the LPF frequency response should be at

$${f}_{{H}_{{f}_{s}}}^{*} + {f}_{s} .$$

$$min {P}_{alis} = {\int }_{BW} {‖ X ( f + {f}_{s} ) {H}_{{f}_{x}} ( {f}_{{H}_{{f}_{*}}}^{*} + {f}_{s} ) ‖}^{2} df \leq {\int }_{BW} {‖ X ( f + {f}_{s} ) {H}_{{f}_{*}} ( f + {f}_{s} ) ‖}^{2} df \qquad ( 5 )$$

Eq. (5) means the LPF frequency response is fixed to a single frequency

$${f}_{{H}_{{f}_{s}}}^{*} + {f}_{s}$$

while the baseband frequency f changes within the measured bandwidth BW. However, this may not be possible. Rewriting equation (5) to make the baseband frequency f determine the LPF frequency response H_{f}_{ₛ}, results in the following equation.

$$min {P}_{alis} = {\int }_{BW} {‖ X ( f + {f}_{s} ) {H}_{{f}_{*}} ( f + Δ f + {f}_{s} ) ‖}^{2} df \qquad ( 6 )$$

$$where$$

$$Δ f = {f}_{{H}_{{f}_{x}}}^{*} - f \qquad ( 7 )$$

Based on Eq. (7), for a baseband frequency f, Δf is defined as a VSA LO offset or simply, LO offset. For any frequency f that is to be measures by the VSA, a different LO offset Δf may be added to shift the center frequency of the signal entering the LPF, H_{f}_{ₛ}, to a reduced, or minimum, value at

$${f}_{{H}_{{f}_{s}}}^{*} + {f}_{s} .$$

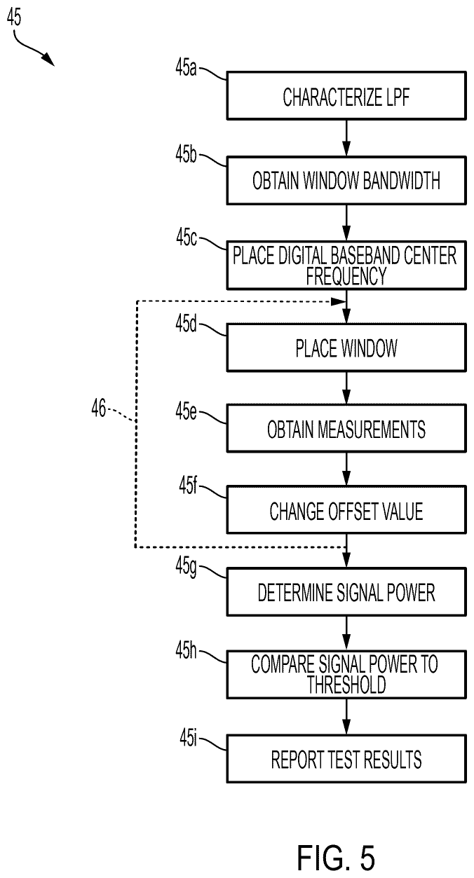

Equations (6) and (7) together thus illustrate a feature of the systems and processes described herein; that is, a frequency domain sliding window, which is described with respect to FIGS. 5, 6, and 7 below. The bandwidth of this sliding window, RBW, is a trade-off between performance and test time. For example, the narrower the window bandwidth is, the more accurate the power measurement may be but the longer the test time may be. Conversely, the wider the window bandwidth is, the less accurate the power measurement may be, but the shorter the test time may be.

The measured power of the interference component in an adjacent channel such as channel 22 (FIG. 2), which has the aliasing component reduced or minimized, may be determined by summing a measurement (e.g., a power measurement) at each window k under BW, as illustrated in equation (8) below.

$$P = {\sum }_{k} ( {\int }_{RBW} {‖ X ( f ) + X ( f + {f}_{s} ) {H}_{{f}_{s}} ( f + {Δf}_{k} + {f}_{s} ) ‖}^{2} df ) \qquad ( 8 )$$

where k is the index of the sliding window (k is an integer ≥1), where Δf is the VSA LO offset for the window k, and where

$${\sum }_{k} ( {\int }_{RBW} 1 df ) = BW \qquad ( 9 )$$

FIGS. 5, 6, and 7, which are described below, illustrate operation of the sliding window and summation explained mathematically using the foregoing equations.

More specifically, FIG. 5 is a flowchart showing example operations performed by an example system, and included in an example process 45, for determining the power of an interference component in an adjacent channel, such as channel 22 of FIG. 2, in such as a way as to remove, to reduce, or to minimize signal power of the aliasing component from the determined power of the interference component. In describing the operations of process 45, reference is made to FIGS. 1, 2, 6, and 7.

In this example, process 45 may be performed using a test system that includes a VSA of the type shown in FIG. 1 controlled by circuitry, which may include one or more computing devices, such as those described herein. Such circuitry or computing device(s) may or may not be part of a test instrument or control system. An example of the circuitry, which may be or include one or more processing devices examples of which are described herein, includes control system 52 of FIG. 1.

Referring to FIG. 1, an example test system that includes the VSA also includes a control system 52. Control system 52 may be configured—e.g., programmed—to communicate 54 with VSA 10 and/or one or more test instruments that include VSA 10 or instances thereof to direct and/or to control testing of DUTs in the manner described herein. In some implementations, this communication 54 may be over a computer network or via a direct connection such as a computer bus or an optical medium. In some implementations, the computer network may be or include a local area network (LAN) or a wide area network (WAN).

Control system 52 may be or include a computing system comprised of one or more processing devices 56 (e.g., microprocessor(s)) and memory 58 for storing machine-executable instructions 60 that are executable by the processing devices to control operation of the test system including the VSA and/or testing to implement at least part of process 45 described below. Process 45 will be described with respect to VSA 10 and control system 52, however, process 45 may be performed using hardware other than this and the other hardware described herein.

Process 45 includes (34) characterizing LPF 17 and determining a reduced or minimum frequency response of LPF 17; for example, the baseband frequency that leads to maximum attenuation of the LPF. This operation may be performed by control system 52, which may be programmed with type and attributes of the LPF. In some implementations, LPF 17 is a fixed LPF having large attenuation (e.g., nulls or zeros) in one or more portions of its stopband.

Characterizing the LPF may include identifying where, in the stop band, an attenuation of LPF 17 is at or above a predefined value. In this regard, attenuation is a reduction in the frequency response of the LPF; accordingly, an increase in attenuation means an increased reduction in the frequency response of the LPF. In some examples, the predefined value is or includes a minimum value among multiple values that are attenuations of the LPF. In some examples, the predefined value at or more than 70 decibels (dB) attenuation relative to the LPF passband.

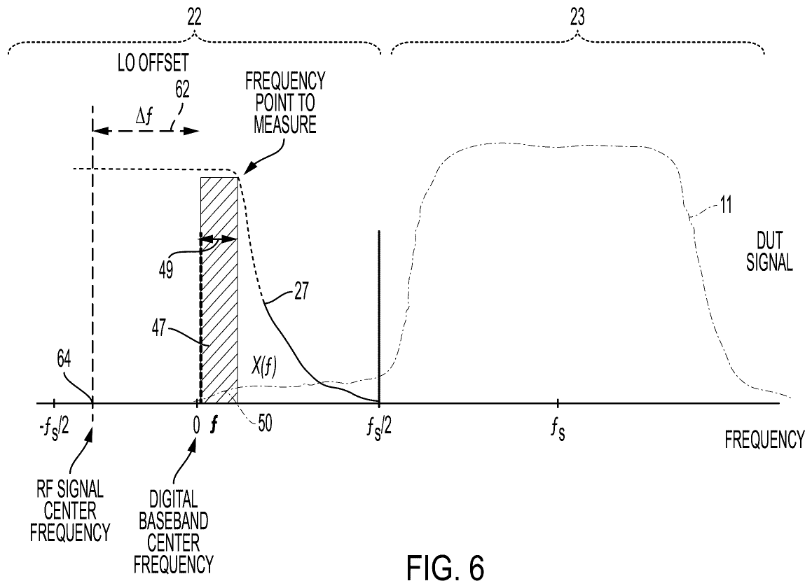

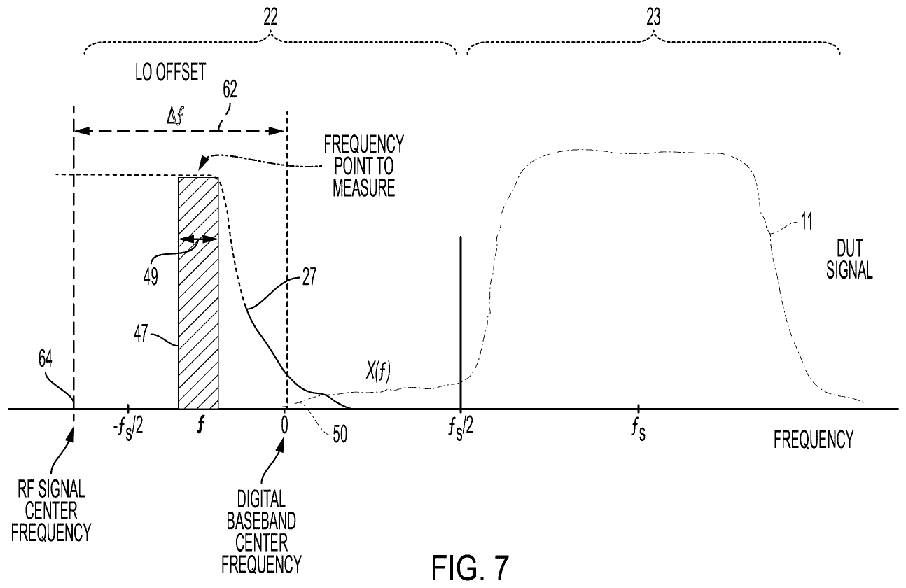

Process 45 includes obtaining (45b) a window bandwidth, RBW, of sliding window 47 (FIGS. 6, 7). This operation may be performed by control system 52, which may be programmed with the bandwidth of adjacent channel, 22 the target performance, and the target test time. By way of example, this information may be programmed into control system 52 by a test engineer prior to performing process 45.

The bandwidth, RBW, of window 47, which may be or include a bandwidth 49 (FIGS. 6, 7) of the window, is settable in or by control system 52 based on the target performance, the target test time, or both the target performance and the target test time. In some implementations, the bandwidth of window 47 does not change during process 45.

The target performance and the target test time may be programmed into control system 52. By way of example, this information may be programmed into control system 52 by a test engineer prior to performing process 45. The target test time may include the amount of time available to test each individual DUT; that is, to test interference caused by signals output by that DUT in channel 22 adjacent to channel 23 where the DUT signals were transmitted. The target performance may include the desired accuracy or resolution of the test. In this regard, smaller-bandwidths, RBW, may produce more accurate determinations of, or relating to, the interference in the adjacent channel 22. However, the smaller the window bandwidth, the more measurements must be obtained, resulting in an increased test time.

Process 45 includes placing (45c) a digital baseband center frequency 50 in adjacent channel 22 as shown in FIGS. 6, 7 by changing the LO frequency of the VSA. Changing the LO frequency changes the center frequency of the signal coming into the LPF. By changing a down conversion frequency for an input signal to LPF 17, the same portion of the RF signal will get attenuated differently by the LPF. A portion of the aliasing component will get attenuated greatly by the high attenuation in the stop band.

Placing the digital baseband center frequency may including assigning the digital baseband center frequency to adjacent channel 22. This may include identifying the bandwidth of adjacent channel 22, which here is −fₛ/2 to fₛ/2, where fₛ is as defined above, and identifying a center of adjacent channel 22 based on the bandwidth. The digital baseband center frequency may be assigned to the center of the adjacent channel. The bandwidth of the adjacent channel may be programmed into control system 52 by a test engineer, for example, or determined by control system 52 to be equivalent to a known bandwidth of channel 23 over which the DUT communicates.

Referring also to FIG. 6, process 45 includes placing (45d) window 47 relative to digital baseband center frequency 50 based on the LO offset Δf 62, which corresponds to a center frequency 64 of LPF 17. In this regard, for a window k 47 (where k is an integer ≥1) the LO offset Δfₖ may be changed as follows:

$$Δ {f}_{k} = {f}_{{H}_{{f}_{s}}}^{*} - {f}_{k}^{c e n t e r} ,$$

where

$${f}_{{H}_{{f}_{s}}}^{*}$$

is a value of the LPF frequency response having an attenuation at or above a predefined value, and where

$${f}_{k}^{c e n t e r}$$

is the digital baseband center frequency 50. The LO offset Δfₖ may be changed based on the bandwidth of the adjacent channel. For example, the LO offset may be increased or decreased to move the window across the channel, as described below, so that an entirety of channel 22 or part of channel 22 is covered by the window to obtain measurements at different frequencies.

Process 45 includes obtaining (45e) a measurement of, or based on, the power of a signal—for example, the interference component—in channel 22 at window 47. The measurement may be a direct measurement of the power or a measurement of other attributes of the signal, such as its amplitude. The measurement may be taken at any location in the window or multiple measurements may be taken across the window and those measurements processed, e.g., averaged, to obtain the measurement of the power. In this example, the power is the power of the interference component produced by the DUT signal in channel 22 with the aliasing component removed, reduced, or minimized. VSA 10 may be controlled by—for example instructed by—control system 52 to obtain (45e) the measurements.

The value of the LO offset Δfₖ is changed (45f) as described above. For example, control system 52 may change the value of the LO offset Δfₖ. Operations 45d to 45f are repeated (46) for different values of the LO offset to obtain the measurements of, or based on, signal power at different frequencies covered by window 47. By changing the down conversion frequency using different values of the LO offset, the same portion of the RF signal will get attenuated differently by the LPF. A portion of the aliasing component will get attenuated greatly by the high attenuation in the stop band of the LPF.

For example, as shown in FIG. 7, the value of VSA LO offset Δfₖ 62 is changed to thereby move window 47 relative to digital baseband center frequency 50, where one or more measurements may be obtained (45e). Thus, process 45 operates by moving or shifting a center frequency of the signal coming into the LPF using the VSA LO across frequencies in channel 22 and obtaining measurements (45e) of, or based on, power of the interference component at different frequencies in channel 22 where an attenuation of LPF 17 is at or above the predefined value.

In some implementations, operations 45d to 45f may be repeated one or more times until measurements are taken across the entirety of the portion of channel 22 where the attenuation of the LPF is at or above the predefined value, e.g., where the frequency response is at or substantially zero in a Z-plane of the LPF.

Process 45 includes determining (45g) the power of the signal—in this example, the interference component—in channel 22 based on the measurements. The power of the signal in channel 22 may be determined by summing the measurements as explained with respect to equation 8 above. By combining—e.g., summing—multiple measurements at different frequencies the contribution from the aliasing signal can be removed, reduced, or minimized.

Because the measurements are obtained at locations where the attenuation of the LPF is at or above the predefined value—for example, the frequency response of the LPF is at or substantially zero in a Z-plane of the LPF—the aliasing component is sufficiently attenuated before being aliased so it is not measured. Accordingly, in some cases, the effect is to remove the contribution of the aliasing component from the measurement of the interference component in channel 22 produced by the DUT signal. In some cases, the effect is to reduce or to minimize the contribution of the aliasing component from the measurement of the interference component in channel 22 produced by the DUT signal.

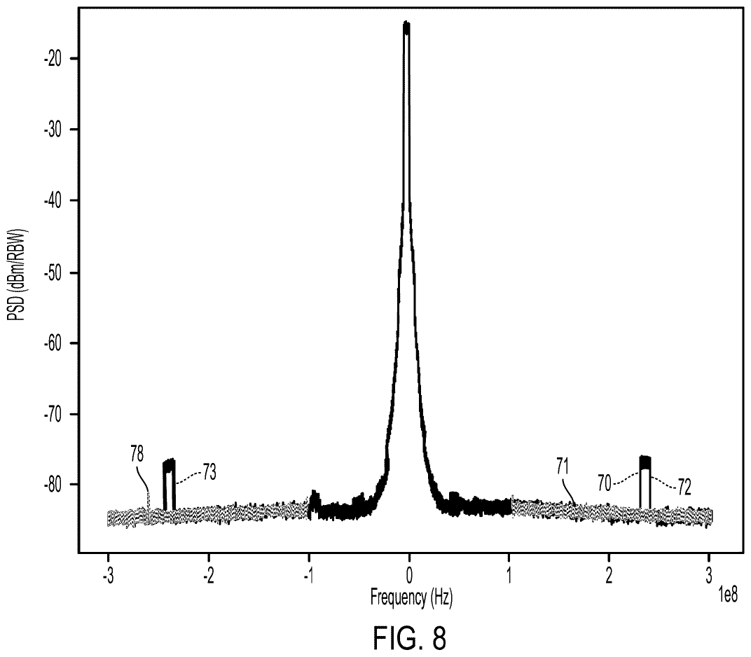

FIG. 8 shows an example narrow bandwidth signal spectrum determination 70 using a prior art technique corresponding to the determination of FIG. 3 and an example narrow bandwidth signal spectrum determination 71 using the systems and processes described herein. As shown, determination 71 by the systems and processes described herein removes all or part of the aliasing component 72, 73 while wholly or substantially maintaining the original signal spectrum characterization. In some implementations, the spur 78 shown to the left is not removed by the processes described herein.

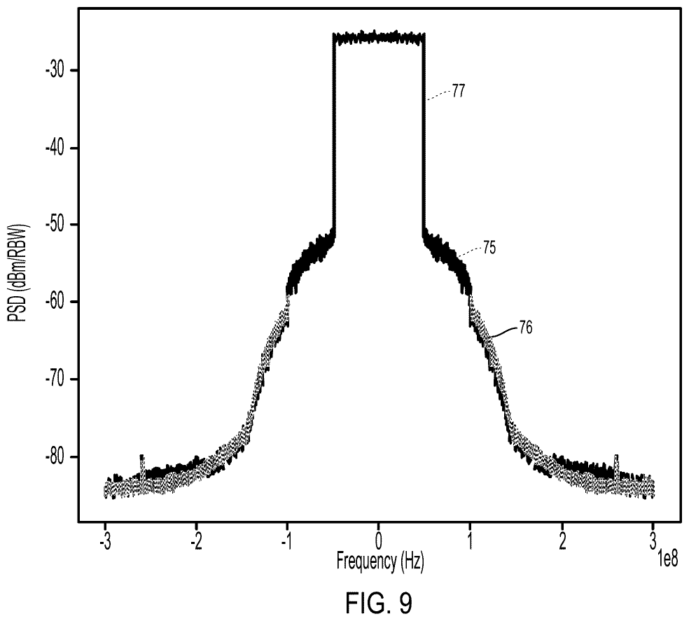

FIG. 9 shows an example wide bandwidth signal spectrum determination 75 using a prior art technique and an example wide bandwidth signal spectrum determination 76 using the systems and processes described herein. As shown, determination 76 by the systems and processes described herein removes all or part of the aliasing component 77 while wholly or substantially maintaining the original signal spectrum characterization.

Referring back to FIG. 5, to test the DUT that transmitted signal 11 in channel 23, process 45 includes comparing (45h) a value of the power of the determined (45g) interference component to a predefined threshold. This operation may be performed by test equipment or other components of a test system configured to test the DUT. The predefined threshold may be programmed into the test system. If the value of the power of the interference component is less than the predefined threshold, then the DUT may pass testing. If the value of the power of the interference component is greater than or equal to the predefined threshold, then the DUT may fail testing. The test system may report (45i) to a user that the DUT passed or failed testing on a user interface or the like and/or may assign passed and failed DUTs to respective bins.

All or part of the systems and processes described herein including but not limited to process 45 and variants thereof may be configured and/or controlled at least in part by one or more computers using one or more computer programs tangibly embodied in one or more information carriers, such as in one or more non-transitory machine-readable storage media. A computer program can be written in any form of programming language, including compiled or interpreted languages, and it can be deployed in any form, including as a stand-alone program or as a module, part, subroutine, or other unit suitable for use in a computing environment. A computer program can be deployed to be executed on one computer or on multiple computers at one site or distributed across multiple sites and interconnected.

Actions associated with configuring or controlling the test system and processes described herein can be performed by one or more programmable processors executing one or more computer programs to control or to perform all or some of the operations described herein. All or part of the test systems and processes can be configured or controlled by special purpose logic circuitry, such as, an FPGA (field programmable gate array) and/or an ASIC (application-specific integrated circuit) or embedded microprocessor(s) localized to the instrument hardware.

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, such as magnetic, magneto-optical disks, or optical disks. Non-transitory machine-readable storage media suitable for embodying computer program instructions and data include all forms of non-volatile storage area, including by way of example, semiconductor storage area devices, such as EPROM (erasable programmable read-only memory), EEPROM (electrically erasable programmable read-only memory), and flash storage area devices; magnetic disks, such as internal hard disks or removable disks; magneto-optical disks; and CD-ROM (compact disc read-only memory) and DVD-ROM (digital versatile disc read-only memory).

As used herein, the terms “comprises,” “comprising,” “includes,” “including,” “has,” “having,” “contains,” “containing,” and any variations thereof, are intended to cover a non-exclusive inclusion, such that systems, techniques, apparatus, structures, processes, or other subject matter described or claimed herein that includes, has, or contains an element or list of elements does not include only those elements but can include other elements not expressly listed or inherent to such systems, techniques, apparatus, structures, processes or other subject matter described or claimed herein.

All examples described herein are non-limiting.

In the description and claims provided herein, the adjectives “first”, “second”, “third”, and the like do not designate priority or order unless context suggests otherwise. Instead, these adjectives may be used solely to differentiate the nouns that they modify.

Any mechanical or electrical connection herein may include a direct physical connection or an indirect physical connection that includes one or more intervening devices unless context suggests otherwise. A connection between two electrically conductive devices includes an electrical connection unless context suggests otherwise. The signals described herein are electrical signals unless context suggests otherwise.

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

Other implementations not specifically described in this specification are also within the scope of the following claims.

What is claimed is:

1. A method of measuring power based on a first signal in a first frequency band, the first signal comprising an interference component of a second signal in a second frequency band that is adjacent to the first frequency band, the method comprising:
changing a frequency using a local oscillator to shift a center frequency of the first signal into a lowpass filter (LPF);
obtaining measurements of power of the interference component at windows in the first frequency band where an attenuation of the LPF is at or above a predefined value; and
determining the power of the interference component in the first frequency band based on the measurements so as to reduce an aliasing component in the first signal caused by the LPF.

2. The method of claim 1, wherein obtaining the measurements where the attenuation of the LPF is at or above the predefined value removes signal power of the aliasing component from the determined power of the interference component.

3. The method of claim 1, wherein obtaining the measurements comprises:
obtaining a bandwidth of a window;
placing a digital baseband in a center of the first frequency band;
placing the window relative to the digital baseband center based on an offset, where placing the window comprises shifting a frequency in the first frequency band;
measuring the power of the interference component in the window; and
repeating placing and measuring for different values of the offset to obtain the measurements.

4. The method of claim 3, wherein measuring is performed using a vector signal analyzer (VSA).

5. The method of claim 2, wherein the offset, Δf is defined as follows:
$$Δf = {f}_{{H}_{{f}_{s}}}^{*} - f$$
where f is the digital baseband center frequency and
$${f}_{{H}_{{f}_{s}}}^{*}$$
is a frequency where the attenuation of the LPF is at or above the predefined value.

6. The method of claim 5, wherein setting the offset comprises changing a value of
$${f}_{{H}_{{f}_{s}}}^{*}$$
at each repetition.

7. The method of claim 6, wherein the value of
$${f}_{{H}_{{f}_{s}}}^{*}$$
is changed at each repetition so that the window covers all frequencies in the first frequency band.

8. The method of claim 3, wherein the bandwidth of the window is settable based on at least one of a target performance or a target test time.

9. The method of claim 1, wherein determining the power comprises summing the measurements.

10. The method of claim 1, wherein the second signal in the second frequency band is generated by a device under test (DUT); and
wherein the method further comprises comparing the power of the interference component to a predefined threshold to test the DUT.

11. The method of claim 1, wherein obtaining the measurements is performed by a vector signal analyzer (VSA) configured to measure signals in less than an entirety of the first frequency band plus the second frequency band.

12. The method of claim 1, wherein the predefined value is a minimum value among multiple values that are attenuations produced by the LPF.

13. The method of claim 1, wherein the predefined value is zero in a Z-plane of the LPF.

14. A system for measuring power based on a first signal in a first frequency band, the first signal comprising an interference component produced by a second signal in a second frequency band that is adjacent to the first frequency band, the system comprising:
a lowpass filter (LPF) having a fixed frequency response; and
circuitry configured to perform operations comprising:
changing a frequency using a local oscillator to shift a center frequency of the first signal into a lowpass filter (LPF);
obtaining measurements of power of the interference component at windows in the first frequency band where an attenuation of the LPF is at or above a predefined value; and
determining the power of the interference component in the first frequency band based on the measurements so as to reduce an aliasing component in the first signal caused by the LPF

15. The system of claim 14, wherein obtaining the measurements where the attenuation of the LPF is at or above the predefined value removes signal power of the aliasing component from the determined power of the interference component.

16. The system of claim 14, wherein obtaining the measurements comprises:
obtaining a bandwidth of a window;
placing a digital baseband in a center of the first frequency band;
placing the window relative to the digital baseband center based on an offset, where placing the window comprises shifting a frequency in the first frequency band;
measuring the power of the interference component in the window; and
repeating placing and measuring for different values of the offset to obtain the measurements.

17. The system of claim 16, wherein at least part of the circuitry is in a vector signal analyzer (VSA).

18. The system of claim 16, wherein the offset, Δf is defined as follows:
$$Δf = {f}_{{H}_{{f}_{s}}}^{*} - f$$
where f is the digital baseband center frequency and
$${f}_{{H}_{{f}_{s}}}^{*}$$
is a frequency where the attenuation of the LPF is at or above the predefined value.

19. The system of claim 18, wherein setting the offset comprises changing a value of
$${f}_{{H}_{{f}_{s}}}^{*}$$
at each repetition.

20. The system of claim 19, wherein the value of
$${f}_{{H}_{{f}_{s}}}^{*}$$
is changed al each repetition so that the window covers all frequencies in the first frequency band.

21. The system of claim 16, wherein the bandwidth of the window is settable based on at least one of a target resolution or a target test time.

22. The system of claim 14, wherein determining the power comprises summing the measurements.

23. The system of claim 14, wherein the second signal in the second frequency band is generated by a device under test (DUT); and
wherein the system further test equipment configured to compare the power of the interference component to a predefined threshold to test the DUT.

24. The system of claim 14, wherein the predefined value is a minimum value among multiple values that are attenuations produced by the LPF.

25. The system of claim 14, wherein the predefined value is zero in a Z-plane of the LPF.
